(19) United States
(12) Patent Application Publication
(10) Pub. No.: US 2025/0161003 A1
(43) Pub. Date: May 22, 2025

(54) DENTAL IMPLANT BODY

(71) Applicants: Masahiko SUZUKAWA, Hiroshima-shi, Hiroshima (JP); KYOCERA CORPORATION, Kyoto (JP)

(72) Inventors: Kosuke FUJISHIMA, Kyoto-shi, Kyoto (JP); Masahiko SUZUKAWA, Hiroshima-shi, Hiroshima (JP)

(21) Appl. No.: 18/843,623

(22) PCT Filed: Feb. 17, 2023
(86) PCT No.: PCT/JP2023/005692

§ 371 Date: Sep. 3, 2024

(30) Foreign Application Priority Data
Mar. 4, 2022 (JP) 2022-033835

(51) Int. Cl. A61C 8/00

(52) U.S. Cl. CPC A61C 8/0018

(57) ABSTRACT

A dental implant body includes a body portion including a front end portion and a rear end portion. The body portion includes a first region including the front end portion and having a tapered shape, a third region closer to the rear end portion than the first region, and a second region located between the first region and the third region and having a cylindrical shape, includes a male screw portion disposed over an outer periphery from the first region to the third region, and includes a recessed portion disposed only on an outer peripheral surface of the male screw portion in the second region and the male screw portion in the third region. The outer periphery of the third region is circular when viewed from an axis direction passing through a rotation center of the male screw portion.

### TECHNICAL FIELD

The present disclosure relates to a dental implant body.

### BACKGROUND OF INVENTION

A dental implant body (dental implant fixture) is known. For example, Patent Document 1 discloses a dental screw-type implant body provided with a cutting edge portion for self-tapping. The cutting edge portion is provided at a lower end of the dental screw-type implant body, i.e., at an end portion as the deepest position when the implant body is implanted in a jaw bone.

For example, Patent Document 2 discloses a non-cylindrical implant body characterized by an eccentricity parameter for primary and secondary fixations to a jaw bone. The eccentricity parameter is defined as a ratio of the maximum distance of a cross-section of an implant volume from a center to a contour of the cross-section to the minimum distance from the center to the contour of the cross-section. Patent Document 2 discloses a dental implant body including a cutting groove as a cutting edge portion at any one of a tooth crown zone, a transition zone, and a tooth root apex or at a plurality of positions.

### CITATION LIST

### Patent Literature

Patent Document 1: JP 2001-321392 A
Patent Document 2: JP 2021-176564 A

### SUMMARY

In an aspect of the present disclosure, a dental implant body includes a body portion including a front end portion and a rear end portion. The body portion includes a first region including the front end portion and having a tapered shape, a third region closer to the rear end portion than the first region, and a second region located between the first region and the third region and having a cylindrical shape, includes a male screw portion disposed over an outer periphery from the first region to the third region, and includes a recessed portion disposed only on an outer peripheral surface of the male screw portion in the second region or a recessed portion disposed only on the outer peripheral surface of the male screw portion in the second region and the male screw portion in the third region. The outer periphery of the third region is circular when viewed from an axis direction passing through a rotation center of the male screw portion.

### BRIEF DESCRIPTION OF THE DRAWINGS

FIG. 1 is a front view of a dental implant body according to a first embodiment of the present disclosure.

FIG. 2 is a right side view of the dental implant body illustrated in FIG. 1.

FIG. 3 is a cross-sectional view taken along line I-I indicated by arrows in FIG. 1.

FIG. 4 is a top view of the dental implant body illustrated in FIG. 1.

FIG. 5 is a diagram illustrating a state where the dental implant body illustrated in FIG. 1 is implanted in a jaw bone.

FIG. 6 is a diagram illustrating a variation of the dental implant body illustrated in FIG. 1.

FIG. 7 is a diagram illustrating another variation of the dental implant body illustrated in FIG. 1.

FIG. 8 is a diagram illustrating a variation of the dental implant body illustrated in FIG. 7.

FIG. 9 is a front view of a dental implant body according to a second embodiment of the present disclosure.

FIG. 10 is a right side view of the dental implant body illustrated in FIG. 9.

FIG. 11 is a cross-sectional view taken along line IX-IX indicated by arrows in FIG. 9.

FIG. 12 is a diagram explaining a method of removing the dental implant body illustrated in FIG. 1 from a jaw bone.

FIG. 13 is a diagram illustrating a conventional dental implant body.

### DESCRIPTION OF EMBODIMENTS

A dental implant body is a bioimplant member that restores the function of a lost tooth root by being implanted into a jaw bone. Therefore, the material, shape, or surface property of the dental implant body is devised to be firmly integrated with the jaw bone. In rare cases, however, the dental implant body must be removed for some reason. In such a case, since the dental implant body is firmly integrated with the jaw bone, the dentist may have difficulty in removing the dental implant body.

An object of an aspect of the present disclosure is to provide a dental implant body having a shape capable of reducing time and effort for removal.

According to an aspect of the present disclosure, a dental implant body having a shape capable of reducing time and effort for removal can be provided.

### First Embodiment

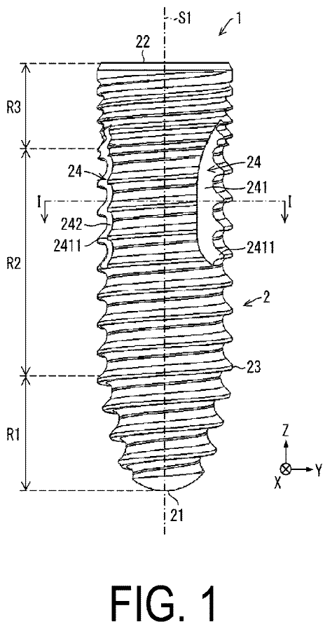

An embodiment of the present disclosure will be described in detail below with reference to FIGS. 1 to 8. In FIG. 1, a direction in which a dental implant body 1 extends is defined as a Z axis direction, a lateral direction of the dental implant body 1 is defined as a Y axis direction, and a direction orthogonal to both the Y axis direction and the Z axis direction is defined as an X axis direction. The X axis positive direction is the depth direction. The Y axis positive direction is the right direction. The Z axis positive direction is the upward direction. The X axis direction, the Y axis direction, and the Z axis direction defined in FIG. 1 are also applied to other drawings. A description “flat surface” only represents a flat surface at a visible level and the surface does not need to be strictly flat. The description “perpendicular” only means being perpendicular at a visible level and does not need to be strictly perpendicular.

### Dental Implant Body

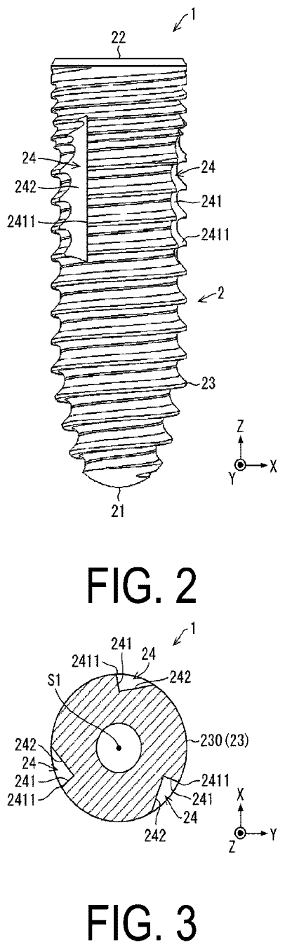

FIG. 1 is a front view of the dental implant body 1 according to the first embodiment of the present disclosure. FIG. 2 is a right side view of the dental implant body 1 illustrated in FIG. 1. FIG. 5 is a diagram illustrating a state where the dental implant body 1 illustrated in FIG. 1 is implanted in a jaw bone 110.

As illustrated in FIGS. 1 and 2, the dental implant body 1 includes a body portion 2 including a front end portion 21 and a rear end portion 22. As illustrated in FIG. 5, the front end portion 21 is a site located on a cancellous bone 113 side of an alveolar bone 111 in a state where the dental implant body 1 is embedded in the jaw bone 110. The rear end portion 22 is a site located on a cortical bone 112 side of the alveolar bone 111 in a state where the dental implant body 1 is embedded in the jaw bone 110, and is located at a boundary between the alveolar bone 111 and a gum 101.

As illustrated in FIG. 1, the body portion 2 includes a first region R1, a third region R3, and a second region R2. The first region R1 is a tapered region including the front end portion 21. The third region R3 is a region located closer to the rear end portion 22 than the first region R1. In the present embodiment, the third region R3 is a cylindrical region including the rear end portion 22 of the body portion 2. The third region R3 may not include the rear end portion 22. The third region R3 may be configured to increase in diameter from the lower side toward the upper side.

The second region R2 is a region located between the first region R1 and the third region R3. As illustrated in FIG. 5, the first region R1 and the second region R2 are regions in contact with the cancellous bone 113 in a state where the dental implant body 1 is embedded in the jawbone 110. As illustrated in FIG. 5, the third region R3 is a region in contact with only the cortical bone 112 in a state where the dental implant body 1 is embedded in the jaw bone 110. In the present embodiment, the third region R3 is in contact with the gum 101 on the rear end portion 22 side.

As illustrated in FIGS. 1 and 2, the body portion 2 further includes a male screw portion 23. The male screw portion 23 is disposed over the outer periphery from the first region R1 to the third region R3. The male screw portion 23 spirally extends from the rear end portion 22 to the front end portion 21. As a result, the dental implant body 1 can be embedded while being screwed into the alveolar bone 111 by self-tapping. In the present embodiment, in a state where the dental implant body 1 is viewed from above, a clockwise direction with respect to an axis S1 passing through the rotation center of the male screw portion 23 corresponds to a direction in which the male screw portion 23 is embedded, and a counterclockwise direction corresponds to a direction in which the male screw portion 23 is removed. In a state where the dental implant body 1 is viewed from above, a clockwise direction with respect to the axis S1 passing through the rotation center of the male screw portion 23 may correspond to a direction in which the male screw portion 23 is removed, and a counterclockwise direction may correspond to a direction in which the male screw portion 23 is embedded.

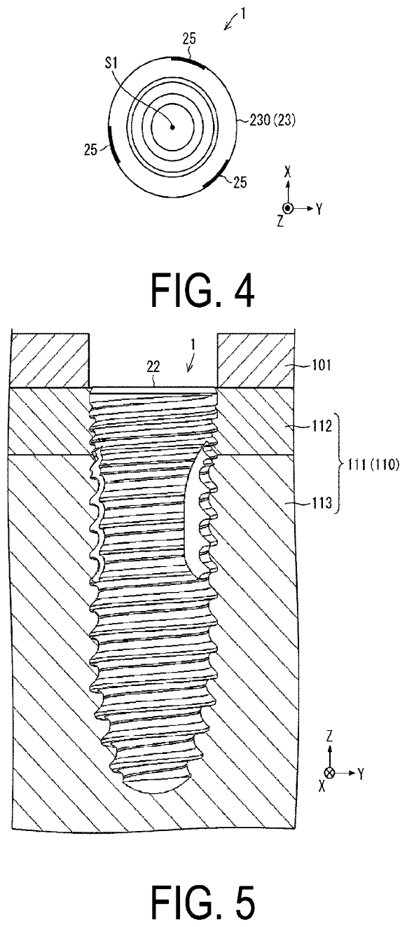

FIG. 4 is a top view of the dental implant body 1 illustrated in FIG. 1. As illustrated in FIG. 4, the outer periphery of the third region R3 (see FIG. 1) is circular when viewed from above. In the present embodiment, since the third region R3 has a cylindrical shape, the outer periphery of the third region R3 also has a circular shape when viewed from below (the axis S1 direction passing through the rotation center of the male screw portion 23).

Here, as illustrated in FIG. 1, the axis S1 passing through the rotation center of the male screw portion 23 is an axis passing through between the front end portion 21 and the rear end portion 22 of the body portion 2, and refers to an axis serving as a rotation axis when rotating the dental implant body 1. That is, the outer periphery of the third region R3 has a shape rotationally symmetrical with respect to the axis S1 passing through the rotation center of the male screw portion 23 from the front end portion 21 side to the rear end portion 22. This can make it easy to remove the dental implant body 1 firmly fixed to the jaw bone 110.

As illustrated in FIG. 4, the dental implant body 1 has, on the rear end portion 22 of the body portion 2, an indication 25 indicating a position where a recessed portion 24 described later is disposed on an outer peripheral surface 230. After the dental implant body 1 is embedded in the jaw bone 110, the recessed portion 24 cannot be recognized, and the position of the recessed portion 24 cannot be known from the outside of the jaw bone 110. Since the dental implant body 1 has the indication 25, the position of the recessed portion 24 can be recognized from the outside even after the dental implant body 1 is embedded in the jaw bone 110, and the process for releasing the fixation between the recessed portion 24 and the jaw bone 110 can be facilitated. In the present embodiment, the indication 25 indicates the width of the recessed portion 24 in the XY plane and is indicated on the rear end portion 22 of the body portion 2 along the outer peripheral surface 230. The indication 25 is not limited to this as long as it indicates the position where the recessed portion 24 is disposed on the outer peripheral surface 230. In other words, the indication 25 may indicate a part of the position where the recessed portion 24 is disposed on the outer peripheral surface 230.

### Recessed Portion

FIG. 3 is a cross-sectional view taken along line I-I indicated by arrows in FIG. 1. As illustrated in FIG. 3, the body portion 2 includes the recessed portion 24. In the present embodiment, the recessed portion 24 is formed by an end surface 241 perpendicular to the outer peripheral surface 230 and a surface 242 perpendicular to the end surface 241. In other words, the end surface 241 constituting the recessed portion 24 and the surface 242 perpendicular to the end surface 241 form an inverted L-shape when viewed from above. The shape of the recessed portion 24 may be any shape as long as it contributes to the fixation after the dental implant body 1 is embedded in the jaw bone 110. In the present embodiment, the recessed portion 24 has a groove-like shape, but may be a hole.

In the present embodiment, the recessed portion 24 is disposed to be continuous with only the outer peripheral surface 230 of the male screw portion 23 in the second region R2 excluding the vicinity of the first region R1 and the male screw portion 23 in the third region R3. In other words, the recessed portion 24 is not disposed on the outer peripheral surface 230 of the male screw portion 23 in the first region R1. According to this configuration, when the dental implant body 1 is removed, the bones around the regenerated bones in the recessed portion 24 located in the vicinity of the first region R1 do not need to be excised with tools. Therefore, the removal of the dental implant body 1 can be facilitated. The recessed portion 24 disposed on the outer peripheral surface 230 of the male screw portion 23 in the second region R2 and the recessed portion 24 disposed on outer peripheral surface 230 of the male screw portion 23 in the third region R3 may not be continuous.

The recessed portion 24 may reach the rear end portion 22 of the outer peripheral surface 230 of the male screw portion 23 in the third region R3, but is disposed at a portion other than the rear end portion 22 in the present embodiment. In a state where the dental implant body 1 is embedded in the jaw bone 110, the rear end portion 22 of the dental implant body 1 is located at a boundary between a bone tissue (jaw bone 110) and a soft tissue (gum 101). However, the recessed portion 24 in the rear end portion 22 may be an infection path for oral bacteria into the jaw bone 110. Disposing the recessed portion 24 at a position other than the rear end portion 22 can reduce the risk of being an infection path for oral bacteria into the jaw bone 110 as described above.

The recessed portion 24 may be disposed not only at the rear end portion 22 of the outer peripheral surface 230 of the male screw portion 23 in the third region R3 but also at a portion other than the vicinity of the rear end portion 22. This can further reduce the risk of being the above-described infection path.

The recessed portion 24 may be disposed only on the outer peripheral surface 230 of the male screw portion 23 in the second region R2. This can further reduce the risk of being an infection path for oral bacteria into the jaw bone 110.

As illustrated in FIG. 3, three recessed portions 24 are disposed on the outer peripheral surface 230. Disposing a plurality of the recessed portions 24 on the outer peripheral surface 230 allows the dental implant body 1 to be more firmly fixed to the jaw bone 110. The number of the recessed portions 24 may be one. When the number of the recessed portions 24 is more than one, the number of the recessed portions 24 is not limited to three as long as it is more than one.

As illustrated in FIG. 3, the recessed portions 24 are disposed at positions rotationally symmetrical with respect to the axis S1 passing through the rotation center of the male screw portion 23. In the present embodiment, the recessed portions 24 are three-fold symmetrical with respect to the axis of the male screw portion 23. Disposing the recessed portions 24 rotationally symmetrically allows the dental implant body 1 to be fixed to the jaw bone 110 in a well-balanced manner. The positions of the recessed portions 24 can be changed according to the number of the recessed portions 24 disposed on the outer peripheral surface 230. For example, when the number of the recessed portions 24 is four, the recessed portions 24 may be four-fold symmetrical with respect to the axis of the male screw portion 23. When a plurality of the recessed portions 24 is disposed on the outer peripheral surface 230, the recessed portions 24 may not be disposed at positions that are rotationally symmetrical with respect to the axis S1 passing through the rotation center of the male screw portion 23. When the number of the recessed portions 24 is more than one, the recessed portions 24 may be disposed along the axis S1 direction passing through the rotation center of the male screw portion 23.

As illustrated in FIGS. 1 to 3, the recessed portion 24 includes the end surface 241 along the axis S1 direction passing through the rotation center of the male screw portion 23. The recessed portion 24 may not include the end surface 241. In the present embodiment, the recessed portion 24 includes the end surface 241 on the counterclockwise side when viewed from above.

The recessed portion 24 includes a cutting edge portion 2411. Here, the cutting edge portion 2411 functions as a cutting edge when the male screw portion 23 is rotated with respect to the axis S1 passing through the rotation center of the male screw portion 23. In other words, the cutting edge portion 2411 can enhance the cutting capability of the dental implant body 1. Thus, when the dental implant body 1 is removed from the jaw bone 110, the cutting edge portion 2411 easily cuts the regenerated bone in the recessed portion 24. Therefore, the removal of the dental implant body 1 can be facilitated.

In the present embodiment, the cutting edge portion 2411 is disposed on the screw thread of the male screw portion 23 of the end surface 241. In other words, at least a part of a ridge portion formed by the end surface 241 and the outer peripheral surface 230 of the male screw portion 23 intersecting with each other is the cutting edge portion 2411. A radius of curvature of the ridge portion may be 100 um or less. Since the cutting edge portion 2411 is disposed on the screw thread of the end surface 241 along the axis S1 passing through the rotation center of the male screw portion 23, the cutting edge portion 2411 can be efficiently used when rotating the dental implant 1. The cutting edge portion 2411 may not be disposed on the end surface 241, and may be disposed in any one of the recessed portions 24. The cutting edge portion 2411 may not be disposed in the recessed portion 24. When the recessed portion 24 is formed by the two end surfaces 241 perpendicular to the outer peripheral surface 230, the cutting edge portions 2411 may be respectively disposed on the screw threads of the male screw portions of the two end surfaces 241. In this case, the removal of the dental implant body 1 can also be facilitated.

The first region R1 occupies one-eighth or more and two-thirds or less of the male screw portion 23 in the axis S1 direction passing through the rotation center of the male screw portion 23. Thus, the recessed portion 24 can be made to an appropriate size. In the present embodiment, as illustrated in FIG. 1, the first region R1 occupies three-eighteenths or more and three-eighths or less of the male screw portion 23 in the axis S1 direction passing through the rotation center of the male screw portion 23. The first region R1 may not occupy one-eighth or more and two-thirds or less of the male screw portion 23 in the axis S1 direction passing through the rotation center of the male screw portion 23.

### Variations

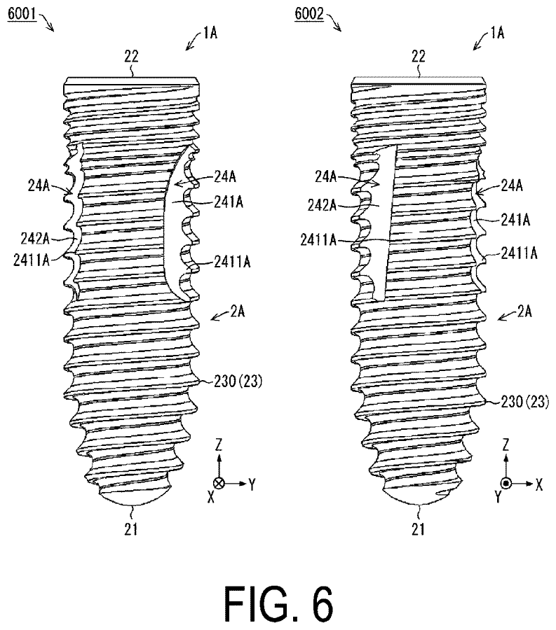

Variations of the present embodiment will be described below using FIGS. 6 to 8. For convenience of description, a member having the same function as that of a member described in the first embodiment described above is denoted by the same reference sign, and description thereof may be omitted.

FIG. 6 is a diagram illustrating a variation of the dental implant body 1 illustrated in FIG. 1. A reference sign 6001 in FIG. 6 represents a front view of a dental implant body 1A. A reference sign 6002 in FIG. 6 represents a right side view of the dental implant body 1A.

As illustrated in FIG. 6, unlike the end surface 241 of the first embodiment, a recessed portion 24A includes an end surface 241A inclined with respect to the axis S1 direction (see FIG. 1) passing through the rotation center of the male screw portion 23. Even in this configuration, the dental implant body 1A has the same effect as the dental implant body 1 in the first embodiment. The dental implant body 1A including the end surface 241A inclined with respect to the axis S1 direction passing through the rotation center of the male screw portion 23 has an effect that resistance during embedding can be reduced.

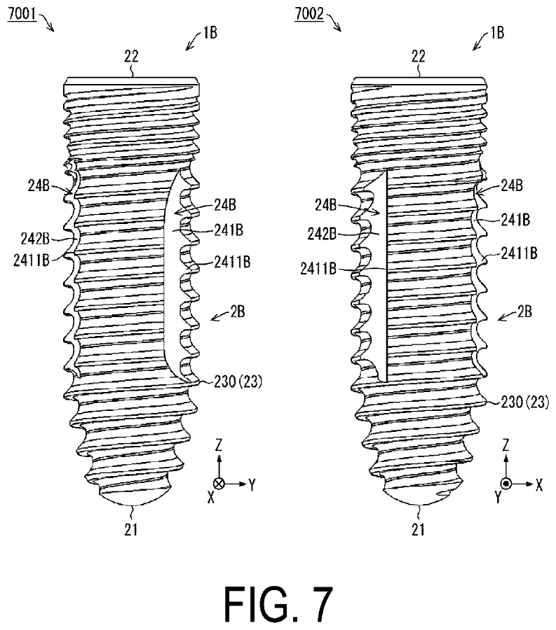

FIG. 7 is a diagram illustrating another variation of the dental implant body 1 illustrated in FIG. 1. A reference sign 7001 in FIG. 7 represents a front view of a dental implant body 1B. A reference sign 7002 in FIG. 7 represents a right side view of the dental implant body 1B.

As illustrated in FIG. 7, unlike the body portion 2, the body portion 2B includes a recessed portion 24B disposed to be continuous with only the outer peripheral surface 230 of the male screw portion 23 in the second region R2 including the vicinity of the first region R1 and the male screw portion 23 in the third region R3. In other words, the recessed portion 24B is disposed on the outer peripheral surface 230 of the male screw portion 23 in the second region R2 up to the upper end portion of the first region R1. Accordingly, when the dental implant body 1B is embedded in the jaw bone 110, a cutting edge portion 2411B can easily shave the alveolar bone 111 in the clockwise direction.

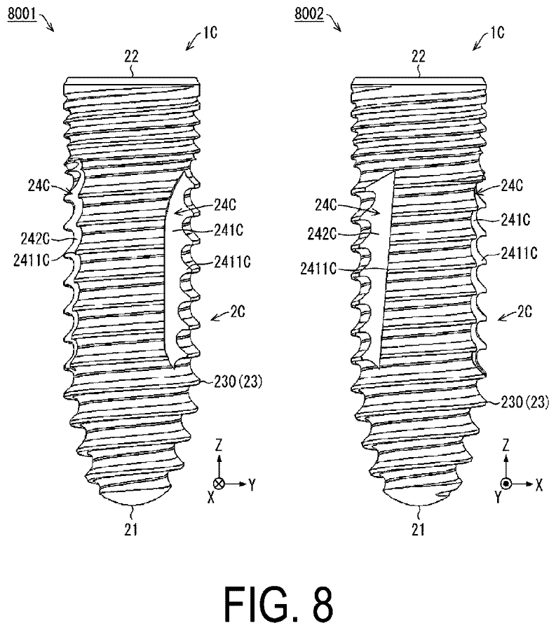

FIG. 8 is a diagram illustrating a variation of the dental implant body 1B illustrated in FIG. 7. A reference sign 8001 in FIG. 8 represents a front view of a dental implant body 1C. A reference sign 8002 in FIG. 8 represents a right side view of the dental implant body 1C. The dental implant body 1C illustrated in FIG. 8 is different from the dental implant body 1A illustrated in FIG. 6 in that a recessed portion 24C is disposed on the outer peripheral surface 230 of the male screw portion 23 in the second region R2 up to the upper end portion of the first region R1.

As illustrated in FIG. 8, unlike the end surface 241B, the recessed portion 24C includes an end surface 241C inclined with respect to the axis S1 direction (see FIG. 1) passing through the rotation center of the male screw portion 23. As a result, when the dental implant body 1C is embedded in the jaw bone 110, the resistance due to the contact surface area between the end surface 241C and the alveolar bone 111 in the axis S1 direction (see FIG. 1) passing through the rotation center of the male screw portion 23 can be reduced.

### Second Embodiment

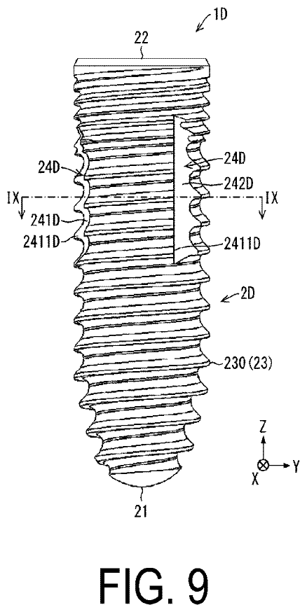

Another embodiment of the present disclosure will be described with reference to FIGS. 9 to 13. For convenience of description, members having the same functions as those of the members described in the above-described embodiment are denoted by the same reference signs, and description thereof is not repeated.

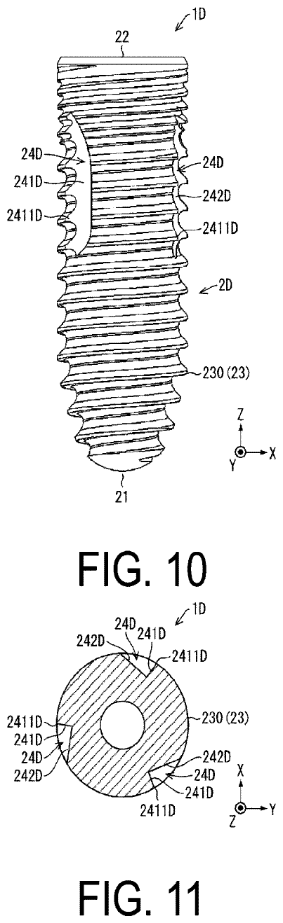

FIG. 9 is a front view of a dental implant body 1D according to a second embodiment of the present disclosure. FIG. 10 is a right side view of the dental implant body 1D illustrated in FIG. 9. FIG. 11 is a cross-sectional view taken along line IX-IX indicated by arrows in FIG. 9.

As illustrated in FIG. 11, a recessed portion 24D includes an end surface 241D on the counterclockwise direction side when viewed from above. A cutting edge portion 2411D has a shape that functions as a cutting edge when rotated in the counterclockwise direction (direction in which the male screw portion 23 is removed). In the present embodiment, the recessed portion 24D is formed by an end surface 241D perpendicular to the outer peripheral surface 230 and a surface 241D perpendicular to the end surface 242D. In other words, the end surface 241D constituting the recessed portion 24 and the surface perpendicular to the end surface 241D form an L-shape when viewed from above. Since the cutting edge portion 2411D is disposed in the removal direction in which the male screw portion 23 is removed, the removal of the dental implant body 1D can be further facilitated. The direction in which the male screw portion 23 is removed may be the clockwise direction. In this case, the counterclockwise direction is a direction in which the male screw portion 23 is embedded in the jaw bone 110.

### Method of Removing Dental Implant Body

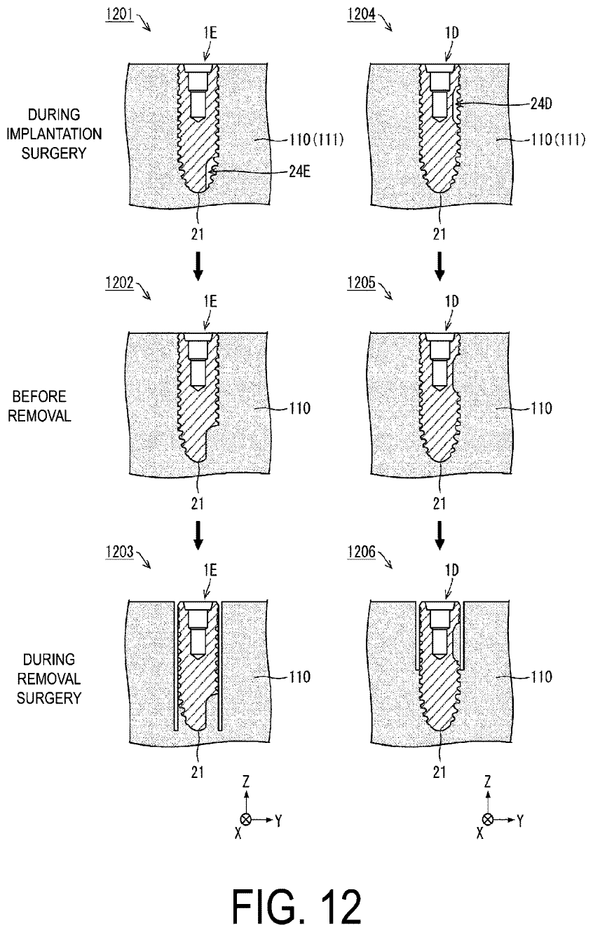

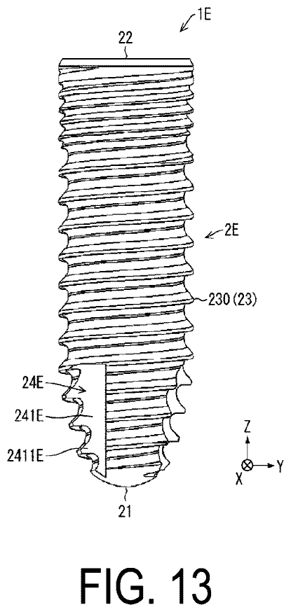

Hereinafter, in the second embodiment, a method of removing the dental implant body 1D will be described with reference to FIGS. 12 to 13. FIG. 12 is a diagram for explaining a method of removing the dental implant body 1D illustrated in FIG. 9 from the jaw bone 110. FIG. 13 is a diagram illustrating a conventional dental implant body 1E.

As illustrated in FIG. 13, unlike the dental implant body 1, the dental implant body 1E includes a recessed portion 24E disposed only on the outer peripheral surface 230 of the male screw portion 23 in the first region R1.

As indicated by a reference sign 1201 in FIG. 12, when the dental implant body 1E is implanted in the alveolar bone 111, a space is formed between the recessed portion 24E and the alveolar bone 111. Next, as indicated by a reference sign 1202 in FIG. 12, before the dental implant body 1E is removed from the jaw bone 110, the jaw bone 110 is regenerated and thus the jaw bone 110 is embedded in the recessed portion 24E. As indicated by a reference numeral 1203 in FIG. 12, when the dental implant body 1E is removed from the jaw bone 110, the jaw bone 110 is shaved with tools from the upper side to the lower side outside the indication 25 up to the vicinity of the recessed portion 24E. Rotating the dental implant body 1E counterclockwise removes the dental implant body 1E from the jaw bone 110 while shaving the jaw bone 110 in the recessed portion 24E.

On the other hand, as indicated by a reference numeral 1204 in FIG. 12, when the dental implant body 1D is implanted in the alveolar bone 111, a space is formed between the recessed portion 24D and the alveolar bone 111. Next, as indicated by a reference numeral 1205 in FIG. 12, before the dental implant body 1D is removed from the jaw bone 110, the jaw bone 110 is embedded in the recessed portion 24D. As indicated by a reference sign 1206 in FIG. 12, when the dental implant body 1D is removed from the jaw bone 110, the jaw bone 110 is shaved with tools from the upper side to the lower side outside the indication 25 up to the vicinity of the recessed portion 24D using the indication 25 indicating the position where the recessed portion 24D is disposed as a mark. In other words, the jaw bone 110 does not need to be shaved with tools from the upper side to the lower side outside the indication 25 up to the vicinity of the front end portion 21 of the dental implant body 1D. Therefore, the dental implant body 1D firmly fixed to the jaw bone 110 can be removed easily compared to the dental implant body 1E. Damage to the jaw bone 110 is smaller than when the dental implant body 1E is removed from the jaw bone 110. The surgical time required to remove the dental implant body 1D from the jaw bone 110 can be shortened.

Rotating the dental implant body 1D counterclockwise removes the dental implant body 1D from the jaw bone 110 while shaving the jaw bone 110 in the recessed portion 24D.

As described above, since the dental implant body 1D does not include the recessed portion 24D in the tapered front end portion 21 and has a rotationally symmetrical shape up to the rear end portion 22 (see FIGS. 9 to 11), the dental implant body 1D firmly fixed to the jaw bone 110 can be easily removed.

The invention according to the present disclosure has been described above based on the various drawings and examples. However, the invention according to the present disclosure is not limited to each embodiment described above. That is, the invention according to the present disclosure can be modified in various ways within the scope presented in the present disclosure, and embodiments obtained by appropriately combining the technical means disclosed in different embodiments are also included in the technical scope of the invention according to the present disclosure. In other words, a person skilled in the art can easily make various variations or modifications based on the present disclosure. Note that these variations or modifications are included within the scope of the present disclosure.

### REFERENCE SIGNS

1, 1A, 1B, 1C, 1D, 1E Dental implant body
2, 2B, 2C, 2D, 2E Body portion
21 Front end portion
22 Rear end portion
23 Male screw portion
24 24A, 24B, 24C, 24D, 24E Recessed portion
25 Indication
230 Outer peripheral surface
241, 241B, 241C, 241D, 241E End surface
2411, 2411A, 2411B, 2411C, 2411D, 2411E Cutting edge portion
R1 First region
R2 Second region
R3 Third region
S1 Axis passing through rotation center of male screw

1. A dental implant body, comprising
a body portion comprising a front end portion and a rear end portion,
wherein the body portion comprises a first region comprising the front end portion and having a tapered shape, a third region closer to the rear end portion than the first region, and a second region located between the first region and the third region and having a cylindrical shape, comprises a male screw portion disposed over an outer periphery from the first region to the third region, and comprises a recessed portion disposed only on an outer peripheral surface of the male screw portion in the second region or a recessed portion disposed only on the outer peripheral surface of the male screw portion in the second region and the male screw portion in the third region, and
the outer periphery of the third region is circular when viewed from an axis direction passing through a rotation center of the male screw portion.

2. The dental implant body according to claim 1, wherein one or more recessed portions are disposed on the outer peripheral surface.

3. The dental implant body according to claim 2, wherein the one or more recessed portions are disposed at positions rotationally symmetrical with respect to an axis of the male screw portion.

4. The dental implant body according to claim 1, wherein the rear end portion has an indication indicating a position at which the recessed portion is disposed on the outer peripheral surface.

5. The dental implant body according to claim 1, wherein the recessed portion comprises a cutting edge portion.

6. The dental implant body according to claim 5,
wherein the recessed portion comprises an end surface along the axis direction of the male screw portion, and
the cutting edge portion is disposed on a screw thread of the end surface.

7. The dental implant body according to claim 5, wherein the cutting edge portion has a shape that functions as a cutting edge when the male screw portion is rotated in a direction of removing the male screw portion.

8. The dental implant body according to claim 1, wherein the recessed portion is disposed at a portion other than the rear end portion.

9. The dental implant body according to claim 1, wherein the first region occupies one-eighth or more and two-thirds or less of the male screw portion in the axis direction of the male screw portion.
